(19) United States
(12) Patent Application Publication
(10) Pub. No.: US 2010/0288889 A1
(43) Pub. Date: Nov. 18, 2010

(54) SPRING FLYING DEVICE

(76) Inventor: Marian Pruzina, Bratislava (SK)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/735,312

(22) PCT Filed: Jan. 2, 2009
(86) PCT No.: PCT/SK2009/050001

§ 371 Date: Jul. 1, 2010

(30) Foreign Application Priority Data
Jan. 2, 2008 (SK) PP 5001-2008

(51) Int. Cl. B64C 29/00

(52) U.S. Cl. 244/23 C; 244/23 R

(57) ABSTRACT

The Spring flying device (1) preferably of circular, oval or polygon shape, capable of vertical take-off and landing, comprises the source (5) of flowing medium (6), which flows through chamber (2) consisting of curved bottom face generating buoyancy during flow (3) and curved top medium attracting face (4). The faces (3) and (4) making up chamber (2) have adequate spacing from each other which allows their interaction still; control is provided by deflection (9) and swivelling (10) flaps, pivot-mounted in chamber (2) and acting upon the flowing medium (6). The device (1) may carry missile ramp (18) with protective guide shield (14) with horizontal (15) and radial (16) deflection flaps which streamline the missile exhaust gases (17) to outer top buoyancy face (12), while the missile exhaust gases (17) may be streamlined to apertures (19) of the chamber simultaneously.

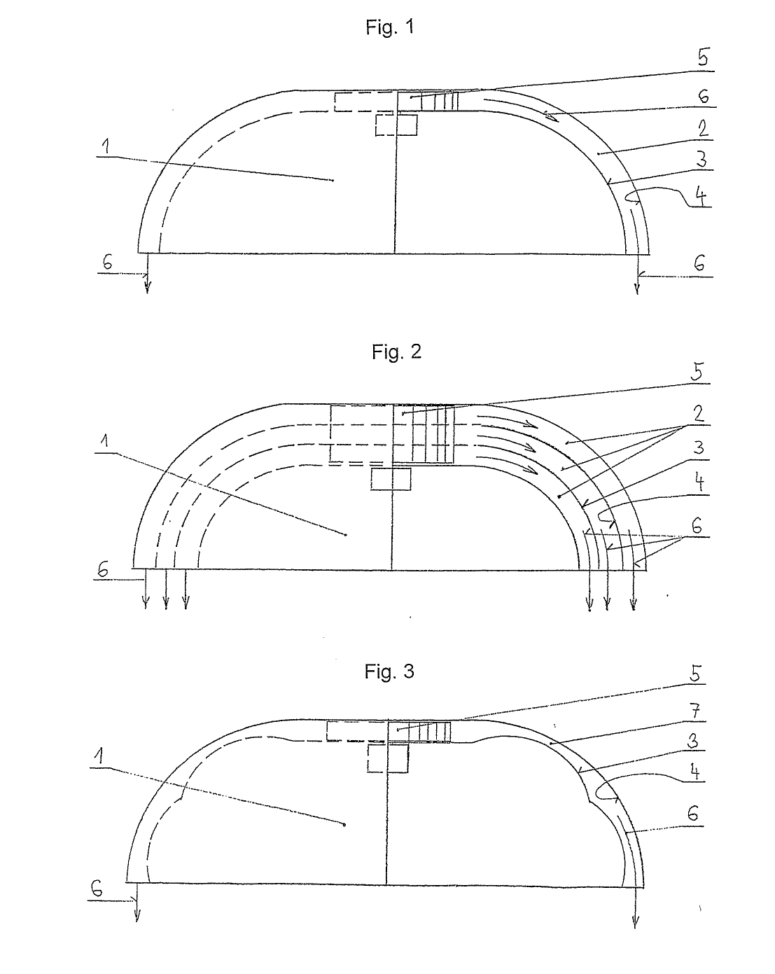

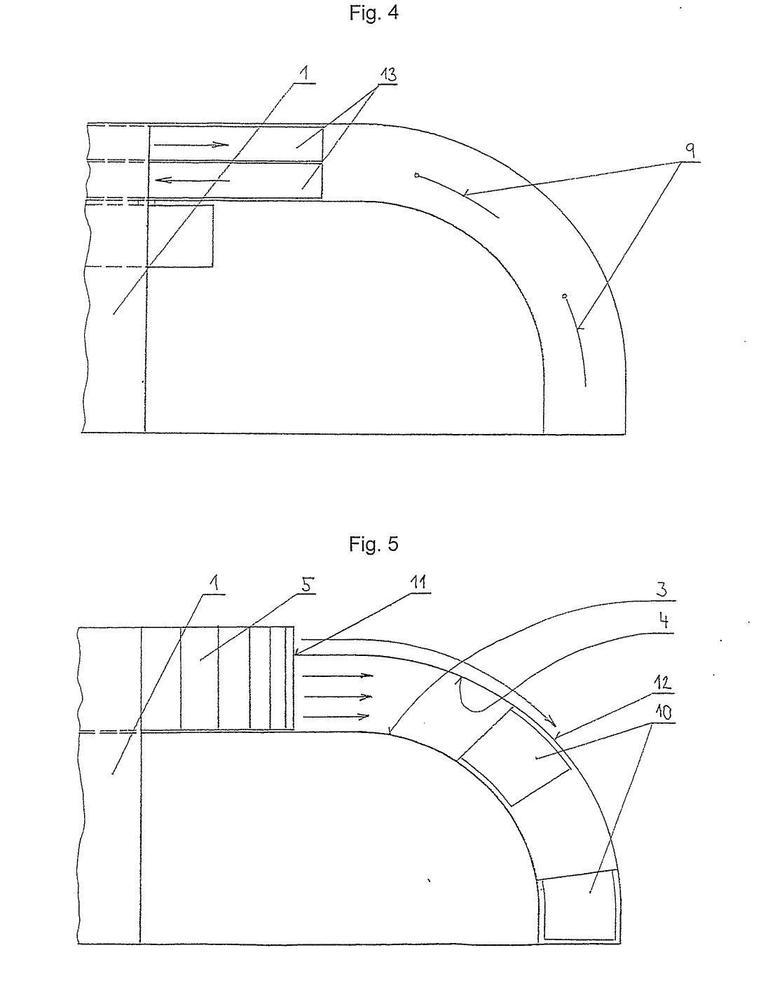

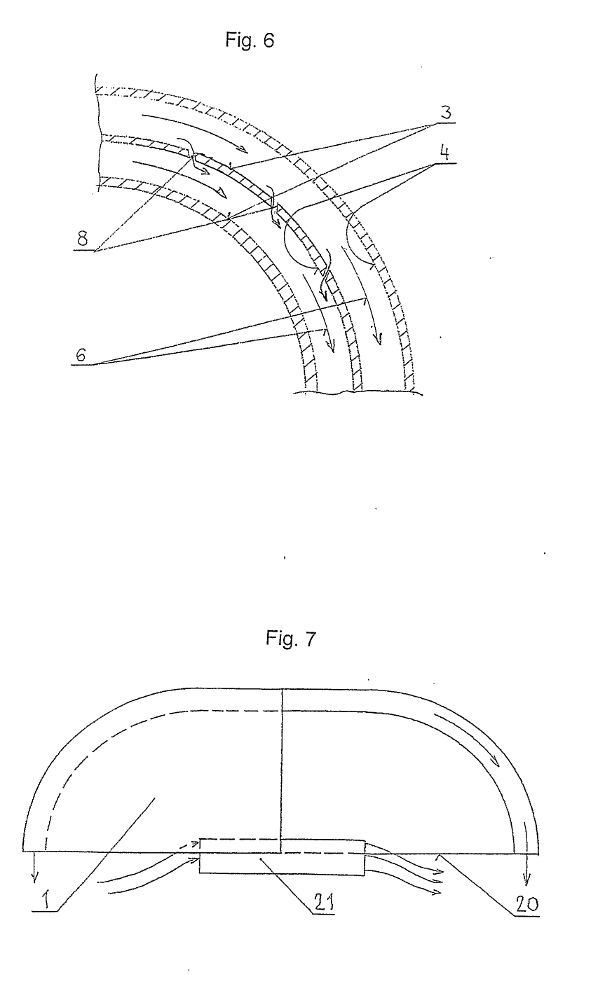

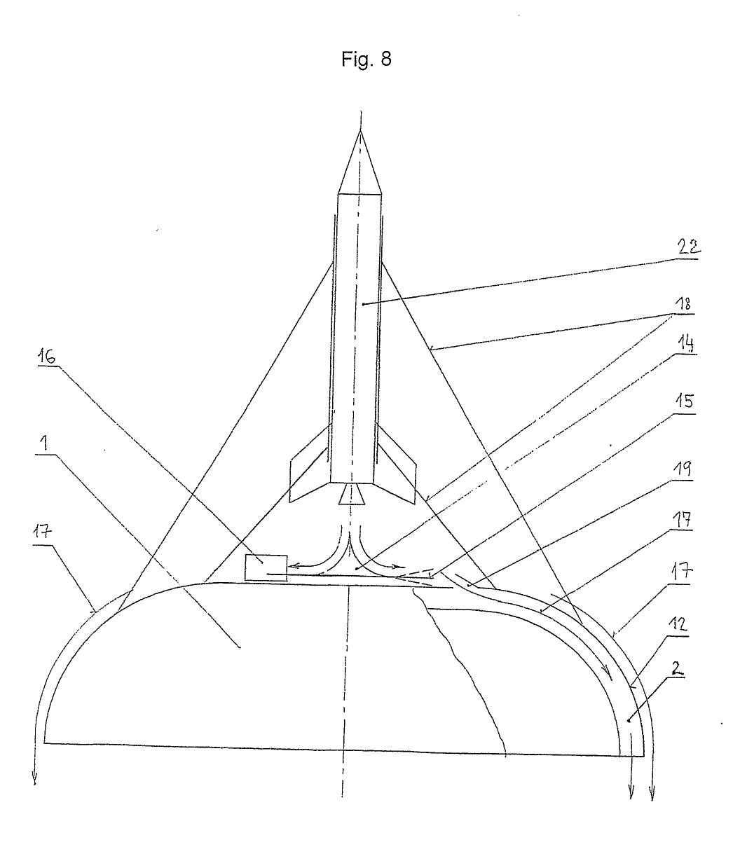

### TECHNICAL FIELD

The invention is related to flying device heavier than air, moving freely in space, and using blowing of curved surface by stream of gases or air to generate buoyancy, and able to take-off and land vertically.

### BACKGROUND ART

Flying devices using the system of blowing of curved surface on which buoyancy is generated have been utilised in numerous technological solutions; most of them have the vertical take-off and landing (VTOL) property.

As examples the solutions given in GB 2387158 or in GB 2424400 and WO 2006/100523 can be quoted, where the generated air stream is streamlined along outside upper curved surface of the device. In patents quoted as U.S. Pat. No. 6,270,036, or in RU 2151717, blowing of outside upper curved face is also used to ensure flying of a device.

When a device is moving in space, for example during horizontal movement forward, air flow along the top surface is affected by surrounding flow which affects the medium flow along the curved surface itself, and thus resulting buoyancy of the device is reduced while a part of the flowing air escapes into the surrounding space.

The device described in U.S. Pat. No. 6,082,478 uses curved face with several chambers for the ground effect. Air stream is forced on curved top face and into chambers of the device to be lifted, while most of the blown-out air leaves the device horizontally at the bottom. Two propellers with reverse rotation are used to drive air in, and thus the reaction moment of propellers is compensated. Upon forward movement the influence of surrounding flows is the same as above; with such manner of gas flow streamlining the effect upon directing a volume of air into individual chambers and to the surface is low, and thus the volume of air flowing through the chambers and along surface cannot be influenced exactly.

### DISCLOSURE OF INVENTION

The invention aims at creating a flying device which makes effective use of created flowing medium, will be resistant with respect to atmospheric effects of the surrounding flowing air, and will be reliable as to operation. The device, preferably of circular, oval or polygon shape, capable of vertical take-off and landing and moving freely in space, can be either remote-controlled in automatic mode, or controlled by the crew on board. The substance of the invention is resolved to a considerable extent by the Spring flying device (“the device”, comprising at least one chamber through which the medium is flowing, and which includes curved bottom and top surfaces at adequate distance from each other. The device contains a source generating flow of the medium through the chamber consisting of curved bottom face capable of generating buoyancy. At certain velocity and with a certain angle the flowing medium adheres to the surface, and when the face is curved in a suitable manner, buoyancy is generated thereon. The buoyancy can be increased by adding a curved top face, which attracts the flowing medium in the chamber, adhered to the surface of the curved bottom face capable of generating buoyancy, and thus the buoyancy force increases. Mutual distance of the faces making up the chamber allows their interaction still. Detaching adhered flow from a surface results in buoyancy reduction at that place, and if the flowing medium is detached from the bottom buoyancy face, buoyancy extinguishes at that place.

At places where the flowing medium is detached from a surface buoyancy is reduced; at the place where the flow is detached from both surfaces buoyancy extinguishes. This is why at the places in the chamber defined in the above manner the height between the two faces is reduced, and thus repeated adhesion of the flowing medium to the faces in the chamber takes place.

For a similar purpose—to avoid the loss of the flowing medium adhesion either to the top or bottom surface in the chamber—apertures of defined shape may be provided to both surfaces at defined spacing, primarily at the flowing medium adhesion loss places; they are used to draw off and control the flowing medium limit layer from any of the surfaces.

To avoid loss of the flowing medium adhesion to the bottom face which is capable of generating buoyancy, or to the top face attracting the flowing medium in the chamber, the deflection flap concurrent with both faces in the chamber will be used; by turning the flap the flowing medium can be streamlined and the situation between the faces can be changed; by help of such flap, the intensity of buoyancy at a given place can be changed and thus bank of the device can be influenced by changing the buoyancy-to-centre of gravity ratio, and movement of the device in the required distance is achieved. Deflection flaps may be located on various places in the chamber; thus, the resulting effect of buoyancy change to the centre of gravity can be enhanced. The deflection flaps may be located in the chamber, along the entire circumference of the device; they may be controlled individually, pairwise, groupwise, or as a whole. Using individual control buoyancy increase or reduction at the place where the deflection flap is mounted will be achieved, and thus buoyancy change will occur at the place in question, as well as changed buoyancy-to-centre of gravity ratio and thus the movement of the entire device will be changed. Analogous change will occur when, for example, pairwise deflection of opposite faces will be used, with one deflection flap turned upwards and the other one downwards; as a result, the reaction of the entire device is more distinctive. This way, groups of flaps can be deflected at a time—pairwise opposite each other, neighbouring side by side, or deflecting flaps in a turning; this way, the buoyancy-to-centre of gravity ratios will be changed.

To turn (swivel) the entire device with respect to the centre of gravity, or to avoid such turning, the swivelling flaps located at various place in the chamber will be used, oriented perpendicularly to both faces in the chamber, in the medium flow direction. To streamline the flow in the chamber the flaps may be located in the top section, or at several places; this way, radial flow will be streamlined. The swivelling flaps located in the bottom section of the device will be most effective: by turning them, stabilisation or swivelling of the device will be achieved sooner, because the flap operates at the longest arm with respect to centre of gravity of the device.

The source of the medium flow, for example a centrifugal compressor, extends over the edge of outside top surface; this way it can be achieved that a part of the medium flows along outside curved part of the device, and a part of the flowing medium passes through the chamber with curved top and bottom faces. The outside top curved face can generate buoyancy as well, and thus the resulting buoyancy force of the entire device will be enhanced.

The source of flowing—centrifugal compressor—comprises one rotor or several rotors with reverse run. With two and more rotors with reverse run mutually eliminating reaction moments are achieved, and thus the source of rotation of the entire device with respect to centre of gravity will be eliminated or suppressed.

On the outside buoyancy face of the device a missile launching equipment is mounted. The equipment can be used as mobile missile carrier with the option to launch missiles at various heights. At missile launching, the exhaust gases are streamlined by protective guide shield avoiding destructive and erosion effects towards outside top surface, and simultaneously streamlining the gases to adhere to the outside top buoyancy-generating face. The buoyancy force will increase with the missile engines exhaust gas flow velocity. The protective guide shield has horizontal deflection flaps streamlining the flowing missile gases in horizontal plane; this way, buoyancy control at this buoyancy face is achieved. The protective guide shield may comprise both radial and deflection flaps which will streamline the flowing missile gases in radial direction, by which stabilisation and rotation of the entire device with respect to vertical axis of the centre of gravity is rectified.

The missile gases (a part thereof) can be directed by the horizontal and radial flaps to the device chamber where acceleration of the flowing medium takes place and thus the buoyancy force in the chamber is increased.

Utilising the missile engine exhaust gases as the flowing medium such resulting buoyancy force can be generated on the device which stabilises its altitude level, or may cause vertical upward or downward movement of the entire device with the starting missile. Stabilisation of the device at certain height by the effect of the starting missile exhaust gases depends upon the ratio of buoyancy generated on the device to the forces acting from the exhaust gases.

In the equipment with closed bottom section, the forward movement source is mounted on this section; a gap will remain between the top curved face attracting the medium, and the bottom curved buoyancy face only. Using the forward movement source such forward velocity will be ensured for the device which will not depend upon buoyancy changes at different places of the device with respect to the centre of gravity, i.e. upon banking of the entire device in the forward direction. Simultaneously, the device modified in the above manner will move in horizontal plane only or at a small angle only, as a buoyancy body.

The device described above allows effective and controlled utilisation of the generated flowing medium; the buoyancy force is higher by approx. 30-40% compared to the device with one outer buoyancy face only; the device is of compact shape which allows good adaptation to surrounding air flow, while being controllable in all movement directions.

Explanation of Used Terms:

Curved bottom buoyancy generating face—the face on which the buoyancy force is generated during the flow; the magnitude of the force depends upon the face shape. The face may by curved downward or upward, but may also be flat.

Curved top buoyancy attracting face—the face, which attracts the flowing medium in the chamber. The face may by curved downward or upward, but may also be flat.

Chamber—is formed by the space between the curved bottom buoyancy generating face and the curved top buoyancy attracting face; the chamber can consist of several chambers situated above each other, so that if there are several chambers, then the curved top buoyancy attracting face has common base with the curved bottom buoyancy generating face, while the curvatures on both faces may be different. Similarly, curvatures of the bottom and top faces for each chamber will be similar in shape, but different.

Medium—flowing air or gas is understood.

The distance between the faces in the chamber is optimal when the flowing medium generates buoyancy and acts upon the bottom face, and simultaneously is being attracted by the top face. The distance depends upon mutual curvatures of the bottom buoyancy generating face and of the top face attracting the flowing medium, upon the medium flow velocity, upon pressure in the chamber, upon adhesion of the materials used, and upon the influences resulting thereof. In case of adhesion loss different measures specified in the patent will be used.

Defined places—exactly localised places in the chamber, on which e.g. buoyancy loss or reduction occurs during the medium flow in the chamber, so that e.g. the deflection flap or exhaustion apertures will be provided there, or the distance (height) between the faces will be reduced, etc.

Apertures of defined shape and distance—the apertures in the curved bottom buoyancy generating face or in the top buoyancy attracting face have the shape which can be different for each curved surface type; this is not the subject of the application, and the defined distance of the above apertures is different on individual surfaces and depends upon a specific surface curvature and flow velocity.

### BRIEF DESCRIPTION OF DRAWINGS

The drawings show embodiments of the Spring flying device according to the invention.

Drawing 1 shows front view of the device in partial section.

Drawing 2 shows front view in partial section, with several chambers.

Drawing 3 shows front view in partial section of the device with preferably reduced mutual chamber height depicted.

Drawing 4 shows partial front view of the device with deflection flaps and the centrifugal compressor.

Drawing 5 shows partial sectional front view of the device, the swivelling flaps and the source of flow exceeding over the edge of the upper surface.

Drawing 6 shows sectional view of a part of the device, with the limit layer exhausting apertures shown.

Drawing 7 shows partial front sectional view with closed bottom side, with the forward movement source indicated.

Drawing 8 shows partial front sectional view of the device with missile ramp and missile.

### BEST MODES FOR CARRYING OUT THE INVENTION

### Example 1

First concrete example of an embodiment of the invention shown in Drawing 1 is the Spring flying device 1, comprising chamber 2 with flowing medium 6, created by source of flow 5, which will adhere to curved bottom face with the ability to generate buoyancy 3. The resulting buoyancy will increase if the flowing medium 6 is simultaneously attracted by the top face 4 attracting the medium.

### Example 2

Drawing 2 also shows a specific example of another embodiment where the device 1 comprises several chambers 2, through which the medium 6 is flowing, generated by the source of flow 5. The resulting buoyancy of the device 1 is the sum of buoyancy values in all chambers 2.

### Example 3

Drawing 3 shows a specific solution of flowing medium 6 adhesion loss at a defined place 7, which can be eliminated by reduction of the mutual height between the buoyancy generating bottom face 3 and the curved medium attracting top face 4, which results in recovery of adhesion of medium 6 to faces 3 and 4.

### Example 4

Forward or backward movement, as well as banking of device 1 in the required direction is achieved by mounting pivoted deflection flaps 9 in chamber 2, shown in Drawing 4. Pivoted deflection flaps 9 act upon the flowing medium 6 such that the flow conditions are changed at the place where they are mounted, and buoyancy increases or decreases at the place in question; this way, a change with respect to centre of gravity of the device 1 occurs. The source of flow 5 is represented by centrifugal compressor 13; when the compressor has two or more rotors, which rotate in reverse direction with respect to each other. With even number of rotors the source of reaction moment with respect to the centre of gravity is eliminated because the reaction moments are mutually eliminated.

### Example 5

If, for example, the source of flow 5 generates the flowing medium 6 from rotating centrifugal compressor 13, a reaction moment occurs which is eliminated by pivoted deflection flaps 10, mounted in chamber 2. By turning the flaps 10 the reaction moment generated also by the rotary parts of centrifugal compressor 13 is balanced. The effect of pivoted deflection flaps 10 rotation of device 1 with respect to the centre of gravity is achieved. Drawing 5 shows a specific case when the source of flow 5 exceeds over the edge of the top face 11, while the flowing medium which is above the edge 11 adheres to curved face 12, which also has the ability to generate buoyancy. Then the resulting buoyancy force of the device 1 will be increased by the buoyancy force generated on the surface 12.

### Example 6

Detachment of flowing medium 6 from the face 3 or 4 in chamber 2 can be avoided by making apertures 8 suppressing the limit layer loss, situated at the places where such loss occurs. The apertures 8 have a defined shape—they need not be circular only—and are located at various spacing from each other.

### Example 7

The device 1 has closed bottom side 20, and then the entire device 1 can fly as a buoyancy body, when moving forward by help of movement source 21.

### Example 8

A concrete example of an embodiment is represented by mounting missile base 18 with missile 22 on the curved buoyancy generating outside face 12 of the device 1, where the protective guide shield 14 streamlines the missile exhaust gases 17 in the horizontal plane by horizontal and vertical flaps 15 and 16, respectively. A part of the missile exhaust gases 17 can be streamlined via the aperture 19 into chamber 2.

### INDUSTRIAL APPLICABILITY

The Spring flying device can be used in aircraft operation as transport device comparable to a plane or a helicopter, preferably under hard performance conditions and where extreme flight and strength properties are required from a flying device. A device with this design can be used for military purposes (surveillance, transport, carrying various interior and exterior machinery, rescue operations, medical emergency rescue, policing, individual air vehicle, or civil air device). Possible use as a suitable air transport means is rather wide (VTOL properties, practically the air volume occupied by the device is sufficient for movement in space; flying through trees—can hit trees and/or tree branches, flying in tunnels, as well as in minimum or maximum heights). The device's flight properties are comparable to those of a helicopter, with the difference that it can fly as a buoyancy body and there are no rotary parts on its outer face. The inner supporting part is protected by the outer face, i.e. the stronger this face (the jacket) the stronger a possible obstacle to be contacted can be.

1. The flying spring device, with a source (5) generating flow of a medium (6), capable of vertical take-off and landing, as well as of manoeuvring motion, remote-controlled, in automatic mode, or by crew on board, characterized by having at least one chamber (2), comprising curved buoyancy generating bottom face (3) and curved medium attracting top face (4), allowing flow of the flowing medium (6), while the flowing medium (6) acts upon both faces (3) and (4) simultaneously.

2. The flying spring device according to claim 1, characterized by mutual height (7) between curved buoyancy generating face (3) and curved medium attracting top face (4) being reduced at defined places in chamber (2).

3. The flying spring device according to claim 1, characterized by apertures (8) of defined shape and spacing exhausting a limit layer provided at defined places of curved buoyancy generating bottom face (3) and curved medium attracting top face (4).

4. The flying spring device according to claim 1, characterized by pivot-mounted deflection flaps (9) provided at defined places in chamber (2), concurrently with curved buoyancy generating bottom face (3) and curved medium attracting top face (4).

5. The flying spring device according to claim 1, characterized by pivot-mounted swiveling flaps (10) provided at defined places in chamber (2), perpendicularly to curved buoyancy generating bottom face (3) and curved medium attracting top face (4).

6. The flying spring device according to claim 1, characterized by the source of flow (5) extending over edge (11) of the outer curved buoyancy generating face (12).

7. The flying spring device according to claim 1, characterized by the source of flow (5) being a centrifugal compressor (13), with one, two or more rotors with reverse rotation direction.

8. The flying spring device according to claim 1, characterized by a missile ramp (18) with a protective guide shield (14) with horizontal (15) and radial (16) deflection flaps mounted on an outer curved buoyancy generating face (12).

9. The flying spring device according to claim 8, characterized by horizontal (15) and radial deflection flaps (16) of the protective guide shield (14) streamlining missile exhaust gasses (17) simultaneously into apertures (19) of chamber (2).

10. The flying spring device according to claim 1, characterized by a source of forward movement (21) provided on a closed bottom side (20) of the device (1).

11. The flying spring device according to claim 1 characterized by the device (1) being of circular, oval or polygon shape.
